(19) United States
(12) Patent Application Publication
(10) Pub. No.: US 2013/0284548 A1
(43) Pub. Date: Oct. 31, 2013

(54) CARBON CERAMIC FRICTION DISKS AND PROCESS FOR THEIR PREPARATION

(71) Applicant: BREMBO SGL CARBON CERAMIC BRAKES GMBH, Meitingen (DE)

(72) Inventors: HANS-MICHAEL GUETHER, KOENIGSTEIN (DE); LUIGI PERSI, TREVIGLIO (IT); CHRISTOPH KOCH, AUGSBURG (DE); MARCO ORLANDI, SEREGNO (IT); MICHAEL KAHLER, RAIN (DE)

(21) Appl. No.: 13/932,454

(22) Filed: Jul. 1, 2013

Related U.S. Application Data
(63) Continuation of application No. PCT/EP2011/074332, filed on Dec. 30, 2011.

(30) Foreign Application Priority Data
Dec. 30, 2010 (EP) 1019447.5

(51) Int. Cl. F16D 65/12

(52) U.S. Cl. CPC F16D 65/126
USPC 188/218 XL; 264/29.1; 156/89.26

(57) ABSTRACT

A multi-layered carbon ceramic brake disk has at least one carrier body, and at least one ventilation layer that containing ventilation ducts, and optionally, at least one friction layer. The brake disk is made by joining green bodies of at least one individual carrier body, green bodies of at least one individual ventilation layer, and optionally, green bodies of at least one individual friction layer. The green bodies contain thermoplastic or thermoset polymeric materials, in their solid or cured states, and by subsequent carbonization and ceramicization by infiltration with carbide-forming elements.

### CROSS-REFERENCE TO RELATED APPLICATION

This is a continuation application, under 35 U.S.C. §120, of copending international application No. PCT/EP2011/074332, filed Dec. 30, 2011, which designated the United States; this application also claims the priority, under 35 U.S.C. §119, of European patent application No. 10197447.5, filed Dec. 30, 2010; the prior applications are herewith incorporated by reference in their entireties.

### BACKGROUND OF THE INVENTION

Field of the Invention

The invention relates to carbon ceramic friction disks, and a process for their preparation.

A friction disk such as a brake disk has several main tasks: it must provide sufficient torsional strength, stiffness and stability to be able to withstand, for example, the torque generated by decelerating a moving vehicle, it must provide an adequate friction coupling with a brake pad by adequate choice of materials which lead to a coefficient of friction of preferably between 0.3 and 0.7, and it must be able to limit the increase in temperature generated by the dissipation of rotational energy as heat.

Brake disks have been described in the literature that solve these tasks by adapting the geometry, for instance by introducing ventilation ducts into grey cast iron brake disks to provide air cooling and thus limiting the operating temperature. The remaining solid top and bottom layers provide the torsional stability and the friction surfaces. Carbon-fiber reinforced carbon disks have been in use in civil and military aircraft, as well as in Formula I racing cars. Also in this type of brake disk, one single material had to be adapted by different geometries to fulfill all tasks. This material had the advantage that the unsprung masses in the racing cars were kept low, due to the low density of the carbon material. Carbon fiber reinforcement accounted for the needed strength and stiffness. But carbon suffers from oxydative degradation at temperatures in excess of 400° C. Brake disks made of carbon-fiber reinforced silicon carbide are stable up to much higher temperatures. Designs including separate friction layers and carrier bodies having high mechanical strength have been described, i.e. in published, non-prosecuted German patent application DE 44 38 456 A1, corresponding to U.S. Pat. No. 6,042,935. Such carrier bodies can also be equipped with hollow spaces which allow to dissipate heat, see German patent DE 44 38 455 C1, corresponding to U.S. Pat. No. 6,086,814.

It was an object of the invention to provide a carbon ceramic brake disk that is optimized to meet all requirements by appropriate selection of the optimum material for each of these tasks, that can be built from standardized components which can be manufactured by processes that can easily be upscaled, and that has also an optimum of force transmission and traction as well as heat transfer between the regions of different materials which make up the brake disk. It has been found that a compound body is able to meet all these requirements, which compound body contains at least one part which provides the needed friction properties, at least one other part which provides the needed torsional strength and stiffness, and at least one further part which provides the needed cooling behavior. It has further been found that a technically reasonable solution is to build the brake disk in separate layers which account for the needed properties.

### BRIEF SUMMARY OF THE INVENTION

An object of the invention is therefore to provide a multi-layered carbon ceramic brake disk having at least one carrier body, and at least one ventilation layer that contains ventilation ducts, and preferably also at least one dedicated friction layer. The brake disk is made by joining green bodies of at least one individual carrier body, and of at least one individual ventilation layer, and preferably, of at least one individual friction layer. The green bodies contain thermoplastic or thermoset polymeric materials, in their solid or cured states, and by subsequent carbonization and ceramicization by infiltration with carbide-forming elements. For use as a brake disk in vehicle applications such as for motor-cars, trucks, and trains, the multi-layered carbon ceramic brake disk of this invention has a symmetrical structure containing a friction layer, a carrier body, a layer containing the ventilation ducts, a second carrier body, and a second friction layer. In a further configuration the brake disk has a symmetrical structure containing a friction layer, a layer containing ventilation ducts, a carrier body, a further layer containing ventilation ducts, and a second friction layer.

It is a further object of the invention to provide a process for the preparation of a multi-layered carbon ceramic friction disk which process includes preparation of a green body for a carrier body by stacking at least two layers of a mixture having a matrix polymer material and reinforcing fibers. Preparation of a green body for a ventilation layer by press molding a mixture having a thermoplastic or thermoset polymeric material, together with cores having substantially the form of the ventilation ducts to be formed, or by injection molding a thermoplastic or thermoset polymeric material into a mold having substantially the form of the ribs, fins or stubs enclosing the ventilation ducts. Optionally, there is a preparation of a green body for a friction layer by injection molding or press molding a mixture containing a thermoplastic or thermoset polymeric material and at least one of fillers and additives which influence the tribological behavior, or by tape or slip casting where a suspension of ceramic particles, preferably silicon carbide, and optionally, particulate carbon, and further optionally, at least one of fillers and additives which influence the tribological behavior, further optionally in the presence of a binder such as a phenolic resin is cast onto a metal belt, spread with a doctor blade, and solidified by drying to form a green tape which is punched according to the needed size of the friction layer. There is further optionally, an application to the interfaces formed in the stack between the green bodies, an adhesive containing at least one of a solution, a paste, and a particulate or powdery solid matter, to improve the bonding between these layers. The green bodies of the at least one carrier body, of the at least one ventilation layer containing ventilation ducts, and optionally, of the at least one friction layer, are stacked to form a stack. Optionally, the stack is subjected to a pressure and thermal treatment, to improve the bonding between these layers. The stack is subjected to pyrolysis in a non-oxidizing atmosphere under heat, to form a carbonized body, and infiltrated with a liquid carbide-forming material, which material preferably contains silicon, to form a ceramic body having a matrix containing a carbide, preferably silicon carbide.

It is a still further object of the invention to provide a process for the preparation of a green body for a friction layer by preparing and injection molding or press molding a mixture containing a thermoplastic or thermoset polymer material, and optionally, fillers and additives which modify the tribological behavior.

A still further object of the invention is to provide a process for the preparation of a green body for a friction layer by slip or tape casting where a suspension of ceramic particles, preferably silicon carbide, and optionally, particulate carbon, and further optionally, at least one of fillers and additives which influence the tribological behavior, further optionally in the presence of a binder such as a phenolic resin is cast onto a metal belt, spread to a predetermined thickness which is even over the usable width, with a doctor blade or a similar measures, and solidified by drying to form a green tape which is punched according to the needed size of the friction layer.

It is a still further object of the invention to provide a process for the preparation of a green body for a carrier body by preparing and pressing a mixture containing a resinous binder, and reinforcing fibers. This green body, and consequently also the carrier body made therefrom, has the shape of a cylinder ring disk having flat and level top and bottom surfaces.

It is a still further object of the invention to provide a process for the preparation of a green body for a ventilation layer by preparing and injection molding or press molding a mixture containing a thermoplastic or thermoset polymeric material and optionally, fillers and additives which modify the strength and stiffness and/or the thermal transfer properties of the resulting body, in a structured mold, or in a cylindrical mold together with cores, the mold structure or the cores having substantially the form of the ventilation ducts to be formed.

The green body for the carrier body is preferably a fiber-reinforced polymer composite material, wherein the fibers must provide adequate stiffness, particularly torsional stiffness which is measured by the torsional modulus, adequate strength and stiffness, particularly torsional strength, and the needed thermal stability. This means that the fibers must be able to withstand the operating temperatures of the brake disks without significant loss in the aforementioned stiffness and strength. The matrix polymer material serves to bind the fibers during the assembling steps, and is then transformed to the final ceramic matrix material by carbonization, and finally, formation of a carbide ceramic material by infiltration with at least one carbide forming element, and subsequent reaction to form the carbide. During carbonization which is a pyrolysis in the absence of air or other oxydizing agents, a porous carbon material is formed from the matrix polymer material which may be either a thermoplastic or a thermoset material, optionally in mixture with fillers and/or additives.

Preferred thermoplastic materials are predominantly aromatic polymers, i.e. polymers that have a mass fraction of aromatic moieties of at least 50%, preferably at least 60%, and particularly preferred, at least 70%. This mass fraction is calculated from the mass of aromatic residues, e. g., phenyl C₆H₅—, phenylene, —C₆H₄—, diphenylene —C₆H₄—C₆H₄—, naphthylene —C₁₀DH₆—, in a polymer such as polyethersulphone —C₆H₄—SO₂—C₆H₄—O— or aromatic polyester —OOC—C₆H₄—COO—C₆H₄—C(CH₃)₂—C₆H₄-, or polyphenylene sulphide —C₆H₄—S—. Other useful materials are polyetherketones, polysulphone, polyphenylene sulphone, and polyetherimide.

Preferred thermoset materials are phenolic resins obtained by addition of formaldehyde to phenol or substituted phenols, and condensation of these addition products, epoxy resins derived from bisphenol A and/or bisphenol F, and furane resins.

Among the additives used, most preferred is pitch, made from distillation residues of crude oil or coal, preferably having a softening temperature of at least 100° C. (DIN 51 920), and a coke yield, measured in accordance with DIN 51905, of at least 80%. Useful fillers are preferably selected from the group consisting of particulate carbon preferably in the form of ground coke, graphite powder, carbon short fibers having an average length of not more than 5 mm, carbon microspheres, powders of carbide forming metals such as silicon, titanium, vanadium, or chromium, and other metals of the groups of the latter three, and powdery non-oxide ceramics such as silicon carbide, silicon nitride, or boron carbide.

The reinforcing fibers are preferably fibers able to withstand high temperatures of more than 500° C., more preferably of at least 800° C., which are preferably selected from the group consisting of carbon fibers, silicon carbide fibers, silicon nitride fibers, boron fibers, boron nitride fibers, boron carbide fibers, aluminum oxide fibers, and zirconium oxide fibers which are stabilized by addition of yttrium oxide to avoid conversion to the monoclinic phase upon cooling.

The reinforcing fibers for the carrier body are preferably used in the form of prepregs, viz., the so-called UD-tapes, which contain filaments in parallel alignment bound by impregnation with the thermoplastic or thermoset material as detailed supra, or in the form of non-woven or woven fiber mats which are also impregnated with the thermoplastic or thermoset material as detailed supra. It is also possible to use filament bundles that are laid in rotationally symmetric forms, such as a series of concentric circles fixed by filament bundles in radial orientation. Such reinforcing elements are commonly referred to as “tailored fiber placement”, and described in European patent EP 1 339 534 B1, corresponding to U.S. Pat. No. 7,942,993.

A preferred method to form the carrier body is to place at least two layers of impregnated UD tapes or fiber mats, woven or non-woven, on top of each other, and choosing the orientation angle so that a symmetrical and homogeneous orientation is achieved. In the case of UD tapes, two such layers are oriented in 0° and 90° with respect to each other, in the case of three UD tape layers, the orientation angles are 0°, 120°, and 240°, and for four layers, 0°, 45°, and 90°, and so forth. In the case of a woven cloth in linen weave, two layers are oriented at 0° and 45°, three layers are oriented at 0°, 30°, and 60°, and so forth. Using impregnated UD tapes or impregnated fiber cloth is preferred because the needed ring-shaped parts may simply be punched out of an impregnated tape or cloth, and then stacked to the needed height. Such process is easily automated.

The green body for the friction layer is preferably made by mixing a thermoset resin, particularly preferred, a phenolic resin or a mixture of a phenolic resin and a pitch, with additives preferably selected from the group consisting of particulate carbon preferably in the form of ground coke, graphite powder, carbon short fibers having an average length of not more than 5 mm, milled carbon fibers having lengths preferably in the range of from 0.1 mm to 2 mm, carbon microspheres, powders of carbide forming metals such as silicon, titanium, vanadium, or chromium, and other metals of the groups of the latter three, and powdery non-oxide ceramics such as silicon carbide, silicon nitride, or boron carbide. It is also possible to use a thermo-plastic resin together with the additives mentioned supra. Homogenizing is in this case preferably made with a mixing extruder, such as a twin screw extruder, which allows the fastest and most homogeneous mixing combined with a minimum of entrapped air. Pelletizing the solidified mixture allows simple and reproducible metering. A Z-arm kneader may be used for mixing both thermoplastic and thermo-set materials. The homogenized mixture is then pressed to the form of a cylinder ring and cured by heating if a thermoset, or pressed at elevated temperature and cooled in the mold if a thermoplastic material is used as matrix. An elegant method to form the green bodies for the friction layer is injection molding. In this case, the mold has to be configured in a way that joint lines are avoided as far as possible, e.g. by a circular gate at the inner circumference of the cylinder ring. Another preferred method to form the green bodies for the friction layer is slip casting or tape casting where a suspension of ceramic particles, preferably silicon carbide, and optionally, particulate carbon, and further optionally, at least one of fillers and additives which influence the tribological behavior, further optionally in the presence of a binder such as a phenolic resin is cast onto a metal belt, spread with a doctor blade, and solidified by drying to form a green tape which is punched according to the needed size of the friction layer. It is preferred in this context to use either particulate carbon, preferably ground coke or graphite flakes, in a mass fraction of at least 20%, based on the sum of masses of the solid constituents in the slip, or a resinous binder such as phenolic resins, epoxy resins or furane resins having a high yield of carbon upon carbonization is present in the slip. Other fillers and additives such as those mentioned supra may, of course, also be present. The liquid used for suspending the particles may be water, or an alcohol such as ethyl alcohol.

The green body for the ventilation layer contains a layer that has cavities and/or indentations that form the cooling channels in the friction disk. The ventilation layer is usually the only layer of those used in the present invention having hollow spaces or indentations, all other layers being massive and without hollow spaces, not counting, of course, the central hole of the ring-disk shape, and the small pores which are created mainly during the carbonization step, and remain unfilled during the infiltration with carbide-forming elements. Preferably, the green body for the ventilation layer contains a base plate which has ribs, fins or stubs on one side, or on both sides of the base plate. The space enclosed between the ribs or fins or stubs forms the cooling channel or cooling duct or ventilation duct in the multi-layered brake disk. The base material used to manufacture the green body for the ventilation layer is preferably also a thermoplastic or thermoset material, preferably also a predominantly aromatic polymer as defined supra. Among the thermosets, also phenolic resins, furane resins, and epoxy resins are preferred. The polymers may contain additives and fillers as described supra. It is also possible to use short carbon fibers up to an average length of 5 mm for reinforcement. Longer fibers are typically not used for the green bodies for the ventilation layers because of the preferred mode of injection molding to form these green bodies. The green body for the ventilation layer is preferably made by injection molding, or by press molding, both processes allowing too realize a wide range of geometries for the cooling ducts. Most preferred is injection molding. A circular gate in the mold is preferred, as in the case of the green body for the friction layer, to avoid the formation of joint lines. In a preferred embodiment, the molded green body for the ventilation layer has a circular rim on the outer and inner circumferences, preferably to both sides in the direction of the axis of rotational symmetry, which allow to geometrically fix the further layers, the green body for the friction layer, and the green body for the carrier body so that symmetrical adjustment is facilitated. These rims form a part of a cylinder jacket at the inner and outer circumferences. It is also possible, in a further embodiment, to build a green body for the ventilation layer from two parts having open recesses and channels on one side, and a base plate on the other side. These two parts have mirror symmetry, and preferably have protrusions and indentations in corresponding locations so that they can be easily fixed upon each other, with the base plates turned outwards in both parts. This is explained in more detail in FIGS. 5A and 5B.

The multi-layered green body for the brake disk is then assembled, in a first embodiment, by stacking a green body for the friction layer, a green body for the carrier body which contains at least two layers of impregnated UD tapes or fiber mats, woven or non-woven, on top of each other, and choosing the orientation angle so that a symmetrical and homogeneous orientation is achieved, a green body for the ventilation layer, a further green body for the carrier body, and a further green body for the friction layer, where, in a preferred embodiment, an adhesive which is preferably a phenolic resins which may also contain powdery silicon carbide or other powdery ceramic fillers or powdery carbon or graphite, is applied between the individual layers. The stack is then pressed and heated to crosslink the adhesive, the subjected to carbonization under exclusion of oxydants at a temperature of preferably from 750° C. to 1300° C. to form a composite body of porous carbon also comprising reinforcing fibers and fillers. The composite body may be machined to remove at least those parts of the circular rim of the ventilation layer which close the cooling ducts, and is then finally subjected to infiltration with silicon or a mixture containing a mass fraction of at least 50% of silicon, and to formation of silicon carbide, and optionally, carbides of other carbide-forming elements present in the mixture with silicon, at a temperature of at least 1420° C., and preferably, under a reduced pressure of between 0.5 hPa and 10 hPa.

Depending on the brake load, other sequences in the stack to form the composite body of porous carbon are preferred, such as for extreme high duty brakes, a sequence of a friction layer, a first carrier body, a first ventilation layer, a second carrier body, a second ventilation layer, a third carrier body, and a final friction layer. The strength of the carrier body can be easily adapted to the load by choosing the number of fibrous reinforcement layers, which is preferably from two to ten. As discussed supra, the individual layers are oriented at different angles to achieve a homogeneous load distribution.

Other features which are considered as characteristic for the invention are set forth in the appended claims.

Although the invention is illustrated and described herein as embodied in carbon ceramic friction disks and process for their preparation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1A-1E are diagrammatic, sectional views through various embodiments of a multilayer brake disk according to the invention;

FIG. 2 is a diagrammatic, plan view of a structured section of a mold;

FIG. 3 is a diagrammatic, sectional view through a carrier body;

FIG. 4 is a diagrammatic, perspective view of the multilayer brake disk; and

FIGS. 5A and 5B are sectional views through green bodies of the multilayer brake disk.

### DESCRIPTION OF THE INVENTION

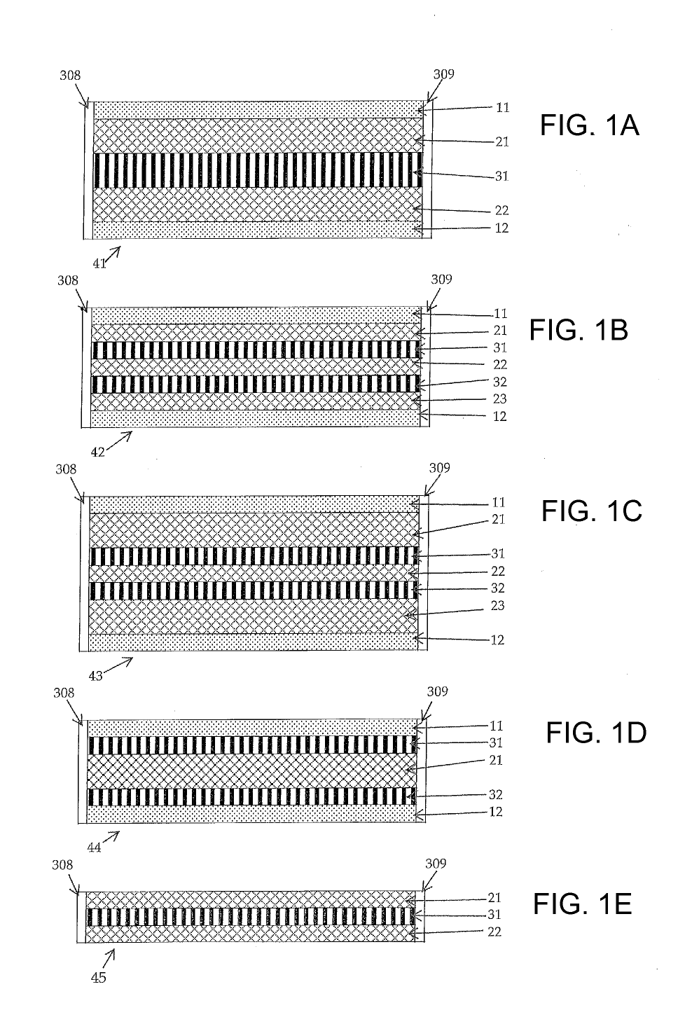

Referring now to the figures of the drawings in detail and first, particularly to FIG. 1A thereof, there is shown a sectional view through a composite green body multi-layered brake disk 41 having a first friction layer 11, a higher width first carrier body 21, a higher width ventilation layer 31, a higher width second carrier body 22, and a second friction layer 12. The brake disk 41 further having a circular rim 309 at an outer circumference, and a circular rim 308 at an inner circumference according to the invention.

FIG. 1B shows a sectional view through a composite green body multi-layered brake disk 42 having the first friction layer 11, the first carrier body 21, the first ventilation layer 31, the second carrier body 22, a second ventilation layer 32, a third carrier body 23, and the second friction layer 12. The brake disk 42 further having the circular rim 309 at the outer circumference, and the circular rim 308 at the inner circumference.

FIG. 1C shows a sectional view through a composite green body multi-layered brake disk 43 having the first friction layer 11, the higher width first carrier body 21, the first ventilation layer 31, the second carrier body 22, the second ventilation layer 32, a higher width third carrier body 23, and the second friction layer 12. The brake disk 43 further having the circular rim 309 at the outer circumference, and the circular rim 308 at the inner circumference.

FIG. 1D shows a sectional view through a composite green body multi-layered brake disk 44 having the first friction layer 11, the first ventilation layer 31, the higher width carrier body 21, the second ventilation layer 32, and the second friction layer 12. The brake disk 44 further having the circular rim 309 at the outer circumference, and the circular rim 308 at the inner circumference.

FIG. 1E shows a sectional view through a composite green body multi-layered brake disk 45 having the first carrier body 21, the first ventilation layer 31, and the second carrier body 22. The brake disk 42 additionally having the circular rim 309 at the outer circumference, and the circular rim 308 at the inner circumference,

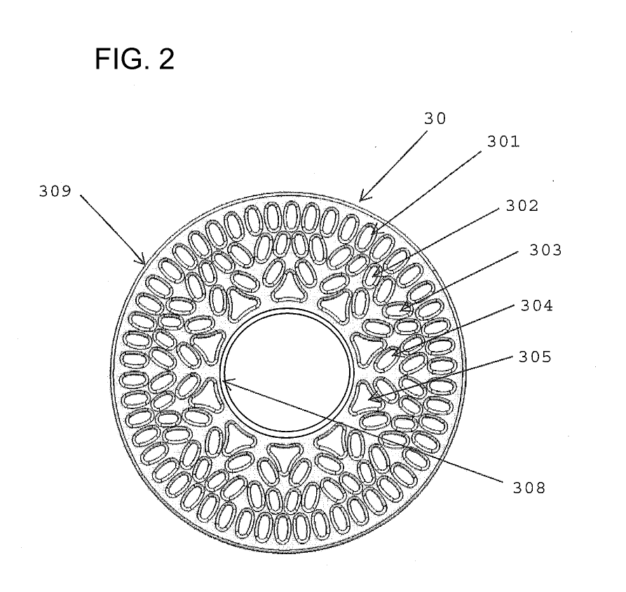

FIG. 2 shows a plan view of a structured section of a mold 30 for injection molding of a green body for a ventilation layer where cavities 301, 302, 303, 304, 305 of elliptical and rounded triangular shape for ribs enclosing the cooling ducts are distributed in a way which allows rotation in both directions for equal ventilation effect. A cavity 308 is provided for the circular rim at the inner circumference and a cavity 309 for circular rim at the outer circumference.

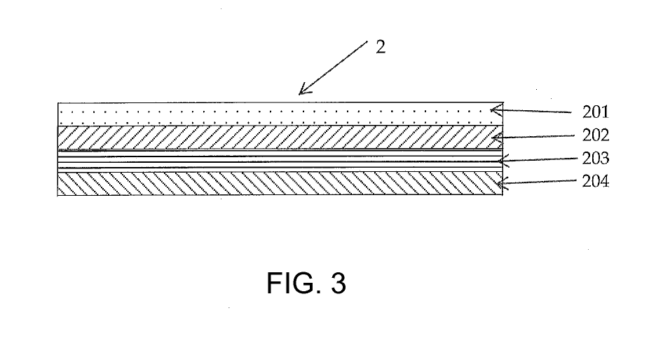

FIG. 3 shows a sectional view through the carrier body 2 having four layers of reinforcing fiber cloth in linen weave at different angles, here layer 201 at 0°, layer 202 at 22.5°, layer 203 at 45°, and layer 204 at 67.5°.

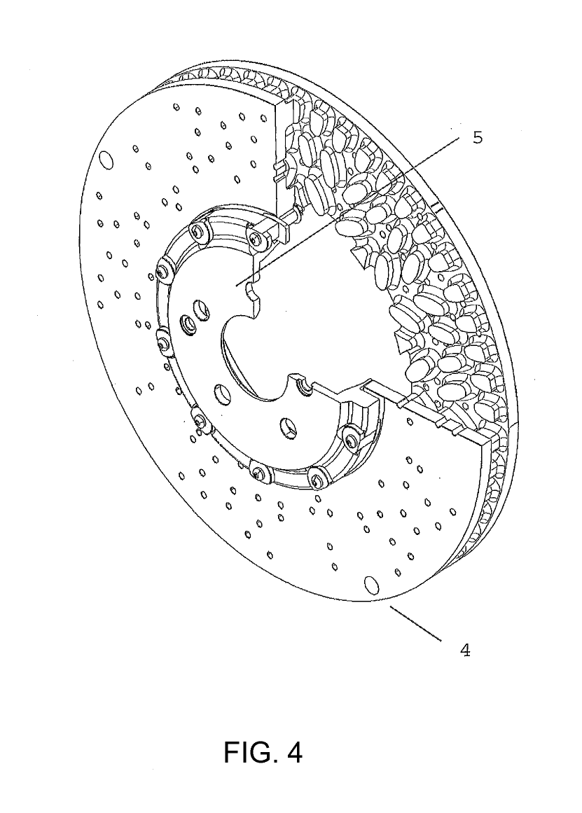

FIG. 4 shows a perspective view of an multilayer brake disk 4 with the layer sequence of FIG. 1A, and the ventilation layer according to FIG. 2, mounted on a hub 5.

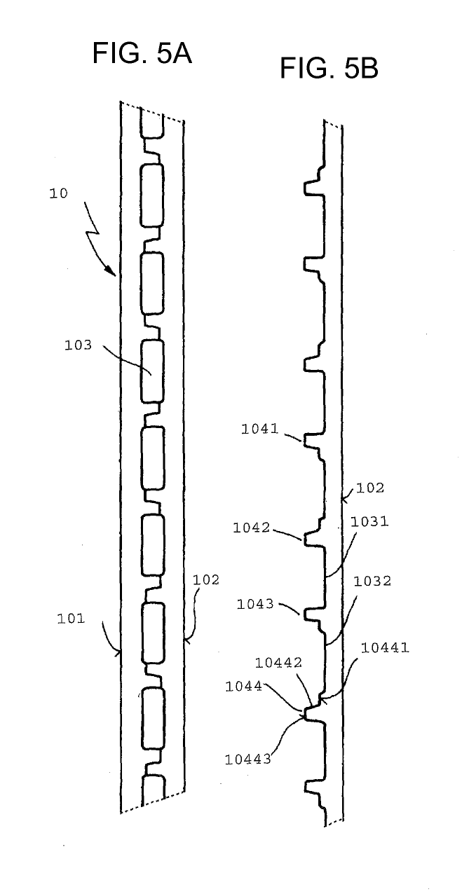

FIGS. 5A and 5B show sectional views. FIG. 5A shows a section through the green body for the ventilation layer of the brake disk of FIG. 4 where the section goes along a circular line with the same center as the axis of the brake disk which circular line intersects the outermost stubs, i.e. those closest to the outer circumference. FIG. 5B shows a section along the same line through one of the two halves of the green body for the ventilation layer which shows the shape of the stubs which interlock with the corresponding stubs of the other half of the green body for the ventilation layer. The section of FIG. 5A shows the ventilation ducts 103 in the green body 10 for the ventilation layer which in a preferred embodiment is made of two halves (101, 102) being the mirror image of each other, which halves 101 and 102 enclose within their combination 10 the ventilation ducts 103. As shown in FIG. 5B, each of the halves 101, 102 has stubs, shown here for 102 which stubs alternate in shape, stub 1041 having the same form as stub 1043, and stub 1042 having the same from as stub 1044. These stubs interlock with those of the other half, by virtue of their profile shape which is selected to form-lock (fit) with its corresponding stub. Of the many possible geometries, one simple variant is depicted in FIG. 5B which has two steps 10441 and 10443 with a slope 10442 separating these steps. The profile form of any two neighboring stubs is selected such that they are a mirror image of each other with respect to the centre of the ground of the ventilation ducts enclosed between them. Thus, stubs 1044 and 1043 are mirror images of each other with respect to the centre of the ground 1032 of the ventilation duct enclosed between them, and stubs 1043 and 1042 are mirror images of each other with respect to the center of the ground 1031 of the ventilation duct enclosed between them, etc. When two such halves 101 and 102 are placed upon each other, with their flat base plates showing away from the joint, the stubs of both halves interlock as shown in FIG. 5A. This variant allows too form the green body for a ventilation layer from two halves, and does not require the use of cores when making the green bodies by injection molding.

By appropriate choice of the sequence and thickness of the individual layers, it is easily possible to adapt the brake disk to the intended purpose. Usually, if present, the friction layers have a thickness of from 1 mm to 5 mm, the ventilation layers have a thickness (which is approximately equivalent to the height of the cooling channels or cooling ducts) of from 5 mm to 20 mm, and the carrier bodies have a thickness of from 3 mm to 20 mm. Particularly in the case where carbon fiber cloth is used as reinforcing element in the carrier body, a construction as explained in FIG. 1E with carrier bodies as outer layers, and without separate friction layers is also possible and gives satisfactory results. The rims used during the assembly to facilitate the stacking may be removed by grinding of turning in the carbonized state, or by grinding in the ceramic state, i.e. after infiltration with liquid silicon, or mixtures thereof.

### EXAMPLE

A green body for a friction layer was prepared as now described.

7.5 kg of silicon carbide powder having an average particle diameter of 40 μm were mixed with 2.5 kg of a phenol resol resin (CELLOBOND® 1203, Momentive Specialty Chemicals Inc.). This mixture was press molded to form flat cylinder ring disks having a thickness of 3 mm, an outer circumference of 400 mm and an inner circumference of 200 mm and cured at 180° C.

A green body for a ventilation layer was injection molded from a mixture of an aromatic polyester resin (bisphenol A-isophthalate-terephthalate copolymer) and a mass fraction of 25%, based on the mass of the mixture, of a powdery pitch of reduced smoking propensity having a softening temperature of 235° C., using a mold according to FIG. 2 having in inner diameter, up to the inner rim, of 199 mm, and an outer diameter, including the outer rim, of 401 mm, a rim thickness of 1 mm, and a rim height below the base plate of 6 mm and beyond the ribs and stubs, also of 6 mm. The height of the ribs and stubs over the base plate was 15 mm.

For the carrier body, a woven carbon fiber tape made of 3 k filament bundles impregnated with phenolic resin (CELLOBOND® 1203) was punched to circular rings having an inner diameter of 200 mm and an outer diameter of 400 mm.

A stack of ten of these rings with a circular displacement of 36° each with regard to the predecessor ring were fixed to each side of the green body for the ventilation layer inside the rims thereof, both sides of the resulting stacks were covered with a green body for the friction layer, the assembly was put into a press mold and pressed at 180° C. with 0.5 MPa for one hour. After cooling to room temperature, the multi-layer green body was subjected to carbonization at 900° C., and was the subjected to infiltration with liquid silicon at 1680° C. After cooling, the inner and outer rims were removed by grinding, the friction layers were drilled to form perforation holes, and the surface of the friction layer was then polished.

The brake disk thus produced showed very good rotational stability (in excess of 5000 min⁻¹).

1. A multi-layered carbon ceramic brake disk, comprising:
at least one carrier body formed from green bodies;
at least one ventilation layer having ventilation ducts formed from green bodies;
at least one friction layer formed from green bodies; and
the multi-layered carbon ceramic brake disk being made by joining said green bodies of said carrier body, said green bodies of said ventilation layer, and said green bodies of said friction layer, all of said green bodies containing thermoplastic polymeric materials or thermoset polymeric materials, in their solid or cured states, and by subsequent carbonization and ceramicization by infiltration with carbide-forming elements, wherein at least one of said green bodies for said carrier body containing at least two layers of a mixture of a matrix polymer material and reinforcing fibers.

2. The multi-layered carbon ceramic brake disk according to claim 1, wherein:
said friction layer is one of two friction layers including a first friction layer and a second friction layer;
said carrier body is one of two carrier bodies including a first carrier body and a second carrier body; and
the multi-layered carbon ceramic brake disk having a symmetrical structure with a sequence of layers of said first friction layer, said first carrier body, said ventilation layer having said ventilation ducts, said second carrier body, and said second friction layer.

3. The multi-layered carbon ceramic brake disk according to claim 1, wherein:
said carrier body is one of two carrier bodies including a first carrier body and a second carrier body; and
the multi-layered carbon ceramic brake disk has a symmetrical structure with a sequence of layers of said first carrier body, said ventilation layer having said ventilation ducts, and said second carrier body.

4. A process for preparation of a multi-layered carbon ceramic brake disk, which comprises the steps of:
preparing green bodies for friction layers by one of injection molding or press molding a mixture having a thermoplastic polymeric material or thermoset polymeric material and at least one of fillers or additives which influence a tribological behavior;
preparing a green body for a carrier body by press molding a mixture having a thermoset resin binder and reinforcing fibers;
preparing a green body for a ventilation layer by one of press molding a mixture having the thermoplastic polymeric material or the thermoset polymeric material, together with cores having substantially a form of ventilation ducts to be formed, or injection molding the thermoplastic polymeric material or the thermoset polymeric material into a mold having substantially a form of one of ribs, fins or stubs enclosing the ventilation ducts;
stacking the green bodies of the at least one friction layer, of the at least one carrier body, of the at least one ventilation layer having the ventilation ducts, to form a stack, where the stack has the green body for the friction layer as a first element and a last element of the stack;
subjecting the stack to pyrolysis in a non-oxidizing atmosphere under heat, to form a carbonized body, and
infiltrating with a liquid carbide-forming material to form a ceramic body having a matrix containing a carbide.

5. The process according to claim 4, which further comprises forming the green body for the carrier body with layers of the reinforcing fibers in one of a form of UD-tapes containing filaments in parallel alignment bound by impregnation with the thermoplastic polymeric material or the thermoset polymeric material, or in a form of non-woven or woven fiber mats which are impregnated with the thermoplastic polymeric material or the thermoset polymeric material.

6. The process according to claim 5, which further comprises:
providing carbon fibers as the reinforcing fibers; and
forming the green body for the carrier body with at least two layers of the reinforcing fibers.

7. The process according to claims 4, which further comprises forming the green body for the carrier body with layers of the reinforcing fibers wherein filament bundles are laid in a form of a series of concentric circles.

8. The process according to claim 4, which further comprises forming the green body for the friction layer with the thermoplastic polymeric material or the thermoset polymeric material.

9. The process according to claim 4, which further comprises forming the green body for the friction layer by mixing a phenolic resin or a mixture of a phenolic resin and a pitch, with additives selected from the group consisting of particulate carbon in a form of ground coke, graphite powder, carbon short fibers having an average length of not more than 5 mm, carbon microspheres, powders of carbide forming metals such as silicon, titanium, vanadium, or chromium, and other metals of the groups of the latter three, and powdery non-oxide ceramics such as silicon carbide, silicon nitride, or boron carbide.

10. The process according to claim 4, which further comprises forming the green body for the ventilation layer with a base plate having ribs, fins or stubs on at least one side of the base plate.

11. The process according to claim 10, which further comprises forming the green body for the ventilation layer with an inner circular rim at an inner circumference and an outer rim at an outer circumference of the base plate, the inner and outer rims forming a part of a cylinder jacket at the inner and outer circumferences.

12. The process according to claim 4, which further comprises pressing and heating the stack, then subjecting the stack to carbonization under exclusion of oxydants at a temperature of from 750° C. to 1300° C. to form a composite body of porous carbon also containing the reinforcing fibers and the fillers, and the composite body of porous carbon is finally subjected to infiltration with silicon or a mixture containing a mass fraction of at least 50% of silicon, and to formation of silicon carbide, and carbides of other carbide-forming elements present in the mixture with silicon, at a temperature of at least 1420° C.

13. The process according to claim 4, which further comprises:
applying to interfaces formed in the stack between the green bodies, an adhesive containing at least one of a solution, a paste, a particulate solid matter or a powdery solid matter, to improve bonding between the green bodies;
subjecting the stack to a pressure and thermal treatment, to improve the bonding between the green bodies;
forming the liquid carbide-forming material to contain silicon; and
forming the carbide as a silicon carbide.

14. A process for preparing a multi-layered carbon ceramic brake disk, which comprises the steps of:
preparing green bodies for friction layers by one of slip casting or tape casting a suspension containing a particulate ceramic material, at least one of a dissolved or emulsified resinous binder having a high carbon yield upon carbonization, and selected from the group consisting of phenolic resins, epoxy resins, and furane resins, and particulate carbon in a form of ground coke or of graphite flake, thermoplastic polymeric material, thermoset polymeric material and at least one of fillers and additives which influence the tribological behavior;
preparing a green body for a carrier body by press molding a mixture containing a thermoset resin binder and reinforcing fibers;
preparing a green body for a ventilation layer by one of press molding a mixture containing the thermoplastic polymeric material or the thermoset polymeric material, together with cores having substantially a form of ventilation ducts to be formed, or injection molding the thermoplastic polymeric material or the thermoset polymeric material into a mold having substantially a form of ribs, fins or stubs enclosing the ventilation ducts;
stacking the green bodies of the at least one friction layer, the green bodies of the at least one carrier body, and the green bodies of the at least one ventilation layer having the ventilation ducts, to form a stack, wherein the stack has one of the green bodies for the friction layer as a first element and last element of the stack;
subjecting the stack to pyrolysis in a non-oxidizing atmosphere under heat, to form a carbonized body; and
infiltrating with a liquid carbide-forming material to form a ceramic body having a matrix containing a carbide.

15. The process according to claim 14, which further comprises forming the green body for the carrier body with layers of the reinforcing fibers in one of a form of UD-tapes containing filaments in parallel alignment bound by impregnation with the thermoplastic polymeric material or thermoset polymeric material, or in a form of non-woven or woven fiber mats which are impregnated with the thermoplastic polymeric material or the thermoset polymeric material.

16. The process according to claim 15, which further comprises:
providing carbon fibers as the reinforcing fibers; and
forming the green body for the carrier body with at least two layers of the reinforcing fibers.

17. The process according to claims 14, which further comprises:
forming the green body for the carrier body with layers of the reinforcing fibers wherein filament bundles are laid in a form of a series of concentric circles; and
forming the green bodies for the friction layers with the thermoplastic polymeric material or the thermoset polymeric material.

18. The process according to claim 14, which further comprises forming the green bodies for the friction layers by mixing a phenolic resin or a mixture of a phenolic resin and a pitch, with additives selected from the group consisting of particulate carbon in a form of ground coke, graphite powder, carbon short fibers having an average length of not more than 5 mm, carbon microspheres, powders of carbide forming metals selected from the group consisting of silicon, titanium, vanadium, chromium, other metals of the groups of the latter three, and powdery non-oxide ceramics being either silicon carbide, silicon nitride, or boron carbide.

19. The process according to claim 14, which further comprises forming the green body for the ventilation layer with a base plate having ribs, fins or stubs on at lest one side of the base plate.

20. The process according to claim 19, which further comprises forming the green body for the ventilation layer with an inner circular rim at an inner circumference and an outer rim at an outer circumference of the base plate, the inner and outer rims forming a part of a cylinder jacket at the inner and outer circumferences.

21. The process according to claim 14, which further comprises pressing and heating the stack, then subjecting the stack to carbonization under exclusion of oxydants at a temperature of from 750° C. to 1300° C. to form a composite body of porous carbon also containing the reinforcing fibers and fillers, and the composite body of porous carbon is finally subjected to infiltration with silicon or a mixture containing a mass fraction of at least 50% of silicon, and to formation of silicon carbide, and carbides of other carbide-forming elements present in the mixture with silicon, at a temperature of at least 1420° C.

22. The process according to claim 14, which further comprises:
applying to interfaces formed in the stack between the green bodies, an adhesive containing at least one of a solution, a paste, particulate solid matter or a powdery solid matter, to improve bonding between the green bodies;
subjecting the stack to a pressure and thermal treatment, to improve the bonding between the green bodies;
forming the liquid carbide-forming material to contain silicon; and
forming the carbide as a silicon carbide.

23. A process for preparing a multi-layered carbon ceramic brake disk, which comprises the steps of:
preparing green bodies for a carrier body by press molding a mixture containing a thermoset resin binder and reinforcing fibers;
preparing a green body for a ventilation layer by one of press molding a mixture containing a thermoplastic polymeric material or a thermoset polymeric material, together with cores having a form of ventilation ducts to be formed, or injection molding the thermoplastic polymeric material or the thermoset polymeric material into a mold having a form of ribs, fins or stubs enclosing the ventilation ducts;
stacking the green bodies of the at least one carrier body, and the green bodies of the at least one ventilation layer having the ventilation ducts, to form a stack, where the stack has a green body for the carrier body as a first element and a last element of the stack;
subjecting the stack to pyrolysis in a non-oxidizing atmosphere under heat, to form a carbonized body; and
infiltrating with a liquid carbide-forming material to form a ceramic body having a matrix containing a carbide.

24. The process according to claim 23, which further comprises forming the green bodies for the carrier body with layers of the reinforcing fibers in one of a form of UD-tapes containing filaments in parallel alignment bound by impregnation with the thermoplastic polymeric material or the thermoset polymeric material, or in a form of non-woven or woven fiber mats which are impregnated with the thermoplastic polymeric material or the thermoset polymeric material.

25. The process according to claim 24, which further comprises:
providing carbon fibers as the reinforcing fibers; and
forming the green bodies for the carrier body with at least two layers of the reinforcing fibers.

26. The process according to claims 23, which further comprises forming the green body for the carrier body with layers of the reinforcing fibers wherein filament bundles are laid in a form of a series of concentric circles.

27. The process according to claim 23, which further comprises forming the green body for the ventilation layer with a base plate having ribs, fins or stubs on at least one side of the base plate.

28. The process according to claim 27, which further comprises forming the green body for the ventilation layer with an inner circular rim at an inner circumference and an outer rim at an outer circumference of the base plate, the inner and outer rims forming a part of a cylinder jacket at the inner and outer circumferences.

29. The process according to claim 23, which further comprises pressing and heating the stack, then subjecting the stack to carbonization under exclusion of oxydants at a temperature of from 750° C. to 1300° C. to form a composite body of porous carbon also containing the reinforcing fibers and the fillers, and the composite body of porous carbon is finally subjected to infiltration with silicon or a mixture containing a mass fraction of at least 50% of silicon, and to formation of silicon carbide, and carbides of other carbide-forming elements present in the mixture with silicon, at a temperature of at least 1420° C.

30. The process according to claim 23, which further comprises applying to interfaces formed in the stack between the green bodies, an adhesive containing at least one of a solution, a paste, particulate solid matter or a powdery solid matter, to improve bonding between the green bodies;
subjecting the stack to a pressure and thermal treatment, to improve the bonding between the green bodies;
forming the liquid carbide-forming material to contain silicon; and
forming the carbide as a silicon carbide.
